(19) United States
(12) Patent Application Publication
(10) Pub. No.: US 2015/0338618 A1
(43) Pub. Date: Nov. 26, 2015

(54) Wafer Lens, Shaping Mold for Wafer Lens, and Production Method for Wafer Lens

(71) Applicant: KONICA MINOLTA, INC., Chiyoda-ku, Tokyo (JP)

(72) Inventors: Hiroumi TANIGAWA, Chiyoda-ku, Tokyo (JP); Toshiyuki IMAI, Chiyoda-ku, Tokyo (JP)

(73) Assignee: KONICA MINOLTA, INC., Chiyoda-ku (JP)

(21) Appl. No.: 14/410,509

(22) PCT Filed: Jun. 11, 2013
(86) PCT No.: PCT/JP2013/066064

§ 371 Date: Dec. 22, 2014

(30) Foreign Application Priority Data
Jun. 22, 2012 (JP) 2012-140887

(51) Int. Cl. G02B 13/00; B29C 35/02

(52) U.S. Cl. CPC G02B 13/0085; B29C 35/02; B29L 2011/0016

(57) ABSTRACT

A wafer lens, includes a substrate; and a resin-molded body which is formed with a distance on at least one surface of the substrate and is composed of a hardenable resin material; wherein the resin-molded body includes a lens portion and at least two alignment mark portions, the lens portion includes an optical surface and a lens annular portion formed at a periphery of the optical surface, and the alignment mark portion includes a flat surface portion on which an alignment mark is formed and a mark annular portion formed at a periphery of the flat surface portion, and wherein a volume at an inside of the lens annular portion of the lens portion is made substantially equal to a volume at an inside of the mark annular portion of the alignment mark portion.

### TECHNICAL FIELD

The present invention relates to a wafer lens, a molding die for a wafer lens, and a method of producing a wafer lens.

### BACKGROUND ART

As a method of producing an imaging lens for an imaging device mounted on mobile terminals in a large amount at low cost, as shown in PTL 1, a known method is configured to produce an imaging lens as follows. That is, a hardenable resin material is coated on a substrate (or on a die), and the hardenable resin material is molded and hardened so as to form a wafer lens. Subsequently, the wafer lens is cut separately into individual lens pieces.

A wafer lens is formed such that multiple small lenses are arranged side by side on a single substrate with a large diameter. Now, description is given briefly to an example of a process of producing the wafer lens. First, a molding die is prepared so as to include a number of molding transferring surfaces and to have a size correspond to the substrate of the wafer lens, such as six inches or eight inches. Then, a hardenable resin material is held and sandwiched between the molding die and the substrate, and the hardenable resin material is hardened by being applied with heat or light. Thereafter, the hardened resin material is released from the molding die, whereby the wafer lens is obtained. To this wafer lens, an antireflection coat and the like are applied if needed, and the wafer lens is cut into individual lenses, whereby a large number of imaging lenses can be obtained by few processes.

### CITATION LIST

### Patent Literature

PTL 1: U.S. Pat. No. 4,420,141

PTL 2: Japanese Unexamined Patent Publication No. 2008-310213

### SUMMARY OF INVENTION

### Technical Problem

Incidentally, in a wafer lens which includes several tens to thousands of lens portions on the same wafer, administration of quality (optical surface configuration, wafer eccentricity, eccentricity between wafers) is important. At the time of molding, at the time of assessment, and at the time of stacking, in order to perform positioning with high precision, it becomes necessary to use an alignment mark portion with such a role. As a method for forming an alignment mark portion, PTL 2 discloses a technique to mold an alignment mark portion with a resin material as with a lens portion.

However, PTL 2 relates to a micro lens array, and in order to form the alignment mark portion, a resin material is coated on the entire surface of a molding die. On the other hand, since a wafer lens is produced for the purpose of mass-producing imaging lenses eventually, it becomes usually necessary to cut the produced wafer lens for each lens portion into individual pieces. Therefore, if a resin material is coated on the entire surface of a molding die of a wafer lens by diversion of the technique of PTL 2, since adjoining lens portions are connected to each other, a phenomenon that lens portions break at a cutting process may happen easily. As a method for avoiding this problem, it is considered not to connect adjoining lens portions with resin. As a method for realizing this, a separately-dropping molding method is effective. In this method, in order to prevent a resin material from spreading over on the entire surface of a glass substrate, the resin material is separately dropped by using a discharging apparatus, such as nozzles so as to dispose droplets individually for each lens portion and to mold them.

On the other hand, the alignment mark portion is requested to be recognized as a mark to perform positioning correctly. Further, in order to produce a wafer lens with a number of lens portions, it is also required to make the position of the alignment mark portion to be recognized easily. Therefore, in the case of forming an alignment mark portion by a resin material, since the alignment mark portion is needed to be shaped in a configuration with sufficient visibility, it is necessary to make the configuration different from that of a lens portion. However, in the case of forming the alignment mark portion by the resin material together with the lens portion, if the configuration of the alignment mark portion is different from that of a lens portion, at the time of dropping the resin material separately, it is necessary to drop the resin material individually in the respective amounts different in accordance with the respective configurations of them. As mentioned above, since a number of lens portions are formed on a wafer lens, the size of each lens portion is small and an arrangement distance between lens portions is also small. Accordingly, if the feeding amount of the resin material is changed only for the alignment mark portion, the resin material may adhere to the neighboring lens portion, or the amount of the resin material may become insufficient. Therefore, there is a fear that it may become difficult to produce an appropriate alignment mark portion.

Further, in the production of a wafer lens with the purpose of mass-producing imaging lenses at low cost, there are request to reduce the number of processes as small as possible and to shorten a tact time (cycle time). However, at the time of producing a lens portion and an alignment mark portion by separately-dropping of a resin material, if a dropping amount of the resin material is changed for each time, there are problems that adjustment and molding time are increased, for example, a trial operation is needed to stabilize a dropping amount of a discharging device (to drop the resin material to a location other than a substrate by trial), and a molding routine work is needed to be changed.

Furthermore, in PTL 2, since the resin material is printed on an alignment mark forming section of a molding die at a process other than an optical surface forming process, there is a fear that a positioning error between processes may occur and it may become difficult to secure the desired visibility of an alignment mark. In addition, there is also a problem that the number of processes increases with a process of printing an alignment mark forming section and a conveying process, which results in an increase of a production cost.

The present invention has been achieved in view of the above situations, and an object of the present invention is to provide a wafer lens with sufficient accuracy in which multiple lens portions and alignment mark portions are formed on a substrate, a molding die to mold this wafer lens, and a method of producing a wafer lens.

### Solution to Problem

A wafer lens described in claim 1 includes a substrate and a resin-molded body which is formed with a distance on at least one surface of the substrate and is composed of a hardenable resin material; wherein the resin-molded body includes a lens portion and at least two alignment mark portions, the lens portion includes an optical surface and a lens annular portion formed at a periphery of the optical surface, and the alignment mark portion includes a flat surface portion on which an alignment mark is formed and a mark annular portion formed at a periphery of the flat surface portion, and wherein a volume at an inside of the lens annular portion of the lens portion is made substantially equal to a volume at an inside of the mark annular portion of the alignment mark portion.

According to the present invention, a volume at an inside of the lens annular portion of the lens portion is made substantially equal to a volume at an inside of the mark annular portion of the alignment mark portion. Accordingly, when a resin material is supplied between the substrate and the molding die by a separately-dropping method, it is permissible to supply a given amount of the resin material. Therefore, it becomes possible to avoid the following problems. When the resin material is supplied too much, a large quantity of the resin material overflows from the cavity of the molding die to mold the alignment mark portion, and the overflowing resin material connects with the neighboring lens portions, which causes cracks at the time of cutting a wafer lens. On the other hand, when the resin material is supplied too small, the alignment mark portion AM cannot be formed with sufficient accuracy. Here, the matter that a volume at an inside of the lens annular portion of the lens portion is made substantially equal to a volume at an inside of the mark annular portion of the alignment mark portion, means that a difference between the two volumes is within ±3%.

In the wafer lens described in claim 2 in the invention described in claim 1, the flat surface portion on which the alignment mark is formed has an outer diameter of 0.14 to 2 mm.

When the flat surface portion on which the alignment mark is formed has an outer diameter of 0.14 mm or more, a difference in area between the flat surface portion and the alignment mark is easily secured widely. Accordingly, when observing with a microscope or a camera, it becomes easy to recognize the alignment mark. On the other hand, when the flat surface portion on which the alignment mark is formed has an outer diameter of 0.2 mm or less, it is desirable, because the mark annular portion can be secured in a proper configuration.

In the wafer lens described in claim 3 in the invention described in claim 1 or 2, the alignment mark is constituted by at least one of a circle, an arc, and a straight line.

When the alignment mark is shaped into a circle configuration, there is an advantage that it is easy to make a transfer surface to transfer it by a machining process. Further, since it can be positioned with sufficient accuracy irrespective of the measuring direction, it is suitable to use it for measurement of an eccentricity in a wafer. Further, when stacking multiple wafers, if an inner diameter is changed, at the time of looking the alignment mark of a rear side wafer superimposed on the alignment mark of a front side wafer, it is desirable, because the alignment mark of a front side wafer does not become obstructive. In this case, it is preferable to make the area of the flat surface portion of the alignment mark at a front side larger than the area of the flat surface portion of the alignment mark at a rear side. On the other hand, when the alignment mark is formed by a line, there is an advantage that it is easy to make a transfer surface to transfer it by a machining process. Further, a line (which includes a cross shape in which lines are orthogonal to each other) allows to measure edges at several points and to obtain an average of the measurements, whereby an error can be eliminated and positioning can be performed with high precision. Accordingly, especially at the time of molding a wafer lens, it is suitable to use it to measure eccentricity between wafers at the time of stacking wafer layers.

In the wafer lens described in claim 4 in the invention described in any one of claims 1 to 3, the diameter of the lens annular portion at a position most distant from the substrate is made equal to the diameter of the mark annular portion at a position most distant from the substrate.

With this, the resin-molded body in which the lens portion and the alignment mark portion coexist together can be arranged easily with equal pitch on the substrate.

In the wafer lens described in claim 5 in the invention described in any one of claims 1 to 4, on a cross sectional surface of the resin-molded body in the optical axis direction passing through the optical axis of the lens portion, the outer shape of the lens annular portion is made substantially the same as the outer shape of the mark annular portion.

With this, the spreading of the resin material at the time of the separately-dropping becomes almost equal in the lens portion and in the alignment mark portion. Accordingly, dispersion in the dropping and the molding decreases, and it becomes easy to keep the quality at constant.

In the wafer lens described in claim 6 in the invention described in any one of claims 1 to 5, in the resin-molded body, the lens portion and the alignment mark portion are arranged with an equal pitch.

The resin-molded body is arranged with a shortened distance on the substrate, whereby the number of the resin-molded bodies per a single substrate is increased so as to enhance a yield.

Further, the resin material is dropped while shifting a dispenser to coat the resin material at an equal speed relatively to the substrate, whereby the supply of the resin material with an equal distance can be realized easily, which is effective for control of a supply amount of a resin material with high accuracy.

In the wafer lens described in claim 7 in the invention described in any one of claims 1 to 6, the lens portions are formed on both sides (i.e., both surfaces) of the substrate, and one of the alignment mark portions is used for positioning at the time of forming the lenses on the both sides of the substrate.

With this, at the time of forming the lenses on the both sides of the substrate, the respective optical axes of the two lens portions can be made coincide with each other with sufficient accuracy.

In the wafer lens described in claim 8 in the invention described in any one of claims 1 to 7, one of the alignment mark portions is used to detect a pitch error of the resin-molded bodies.

With this, whether the pitch of the lens portions is formed with sufficient accuracy can be judged. Accordingly, occurrence of defective products can be suppressed.

In the wafer lens described in claim 9 in the invention described in any one of claims 1 to 8, at the time of stacking multiple wafer lenses in the form of one on top of another, one of the alignment mark portions is used for positioning of the wafer lenses to be stacked.

With this, the respective optical axes of the lens portions disposed in the stacked wafer lenses can be made coincide with each other at once with sufficient accuracy.

A wafer lens molding die described in claim 10 is a wafer lens molding die which is arranged to face at least one surface of a substrate and is configured to form a resin-molded body including a lens portion and at least two alignment mark portions by sandwiching a hardenable resin material with the substrate therebetween. The wafer lens molding die comprises a lens cavity for forming the lens portion and a mark cavity for forming the alignment mark portion, wherein the lens cavity includes an optical surface forming section for forming an optical surface of the lens portion and a lens annular portion forming section for forming a lens annular portion around the optical surface, and the mark cavity includes a flat surface portion forming section for forming a flat surface portion of the alignment mark portion and a mark annular portion forming section for forming a mark annular portion around the flat surface portion, and wherein the volume of the lens cavity and the volume of the mark cavity are made substantially equal to each other.

According to the present invention, the volume of the lens cavity and the volume of the mark cavity are made substantially equal to each other. Accordingly, when a resin material is supplied between the substrate and the molding die by a separately-dropping method, it is permissible to supply a given amount of the resin material. Therefore, it becomes possible to avoid the following problems. When the resin material is supplied too much, a large quantity of the resin material overflows from the cavity of the molding die to mold the alignment mark portion, and the overflowing resin material connects with the neighboring lens portions, which causes cracks at the time of cutting a wafer lens. On the other hand, when the resin material is supplied too small, the alignment mark portion AM cannot be formed with sufficient accuracy. Here, the matter that the volume of the lens cavity and the volume of the mark cavity are made substantially equal to each other, means that a difference between the two volumes is within ±3%.

In the wafer lens molding die described in claim 11 in the invention described in claim 10, the flat surface portion forming section has an outer diameter of 0.14 to 2 mm.

When the flat surface portion forming section has an outer diameter of 0.14 mm or more, a difference in area between the flat surface portion formed by the flat surface portion forming section and the alignment mark is easily secured widely. Accordingly, when observing with a microscope or a camera, it becomes easy to recognize the alignment mark. On the other hand, when the flat surface portion forming section has an outer diameter of 0.2 mm or less, it is desirable, because the mark annular portion formed by the mark annular portion forming section can be secured in a proper configuration.

In the wafer lens molding die described in claim 12 in the invention described in claim 10 or 11, on the flat surface portion forming section, a concave potion or a convex portion each constituted by at least one of a circle, an arc, and a straight line, is disposed, and the alignment mark is formed by transferring the concave potion or the convex portion.

When the alignment mark is shaped into a circle configuration, there is an advantage that it is easy to make a transfer surface to transfer it by a machining process. Further, since it can be positioned with sufficient accuracy irrespective of the measuring direction, it is suitable to use it for measurement of an eccentricity in a wafer. On the other hand, when the alignment mark is formed by a line, there is an advantage that it is easy to make a transfer surface to transfer it by a machining process. Further, a line (which includes a cross shape in which lines are orthogonal to each other) allows to measure edges at several points and to obtain an average of the measurements, whereby an error can be eliminated and positioning can be performed with high precision. Accordingly, especially at the time of molding a wafer lens, it is suitable to use it to measure eccentricity between wafers at the time of stacking wafer layers.

In the wafer lens molding die described in claim 13 in the invention described in any one of claims 10 to 12, the concave portion or the convex portion is processed immediately after the mark cavity has been processed.

With this, since the center of the mark cavity and the center of the concave portion, or the convex portion are made coincide with each other with sufficient accuracy, it becomes possible to enhance the positional accuracy of an alignment mark formed by being transferred. Further, since the concave portion, or the convex portion is processed on the flat surface portion, an alignment mark with high precision and high reproducibility is created.

In the wafer lens molding die described in claim 14 in the invention described in any one of claims 10 to 13, the diameter of the lens annular portion forming section at the deepest position is made equal to the diameter of the mark annular portion forming section at the deepest position.

With this, the resin-molded body in which the lens portion and the alignment mark portion coexist together can be arranged easily with equal pitch on the substrate.

In the wafer lens molding die described in claim 15 in the invention described in any one of claims 10 to 14, when taking a cross sectional surface, the outer shape of the lens annular portion forming section is made substantially the same as the outer shape of the mark annular portion forming section.

With this, when molding a resin material supplied at the time of the separately-dropping, the spreading of the resin material becomes almost equal in the lens annular portion formed by the lens annular portion forming section and in the mark annular portion formed by the mark annular portion forming section. Accordingly, dispersion in the dropping and the molding decreases, and it becomes easy to keep the quality at constant.

In the wafer lens molding die described in claim 16 in the invention described in any one of claims 10 to 15, a distance between neighboring lens cavities is made equal to a distance between the neighboring lens cavity and the mark cavity.

A distance between neighboring lens cavities is made equal to a distance between the neighboring lens cavity and the mark cavity, whereby these cavities are arranged with a shortened distance, the number of the resin-molded bodies per a single substrate is increased so as to enhance a yield. Further, the resin material is dropped while shifting a dispenser to coat the resin material at an equal speed relatively to the substrate, whereby the supply of the resin material with an equal distance can be realized easily, which is effective for control of a supply amount of a resin material with high accuracy.

In the wafer lens molding die described in claim 17 in the invention described in any one of claims 10 to 16, the molding die includes a resin-made molding transferring surface obtained by being transferred from the master die.

With this, by molding only the master die serving as a single die, an accurate molding die can be easily duplicated.

In a wafer lens producing method described in claim 18 is a producing method of producing a wafer lens by using the molding die described in any one of claims 10 to 17, includes a process of supplying a hardenable resin material separately between the substrate and each of the lens cavity and the mark cavity, and a process of detecting a pitch error of a resin-molded body formed on the substrate by using an alignment mark portion formed by the mark cavity.

According to the present invention, the wafer lens producing method includes a process of detecting a pitch error of a resin-molded body formed on the substrate by using an alignment mark portion formed by the mark cavity. By detecting the alignment mark, whether the pitch of the lens portions is formed with sufficient accuracy can be judged. Accordingly, occurrence of defective products can be suppressed.

In a wafer lens producing method described in claim 19 is a producing method of producing a wafer lens by using a pair of the molding dies described in any one of claims 10 to 17, includes a process of supplying a first hardenable resin material separately between one surface of the substrate and each of the lens cavity and the mark cavity of one of the molding dies; a process of positioning anther one of the molding dies on another surface of the substrate by using an alignment mark portion formed by the mark cavity; and a process of supplying a second hardenable resin material separately between another surface of the substrate and each of the lens cavity and the mark cavity of another one of the molding dies.

According to the present invention, at the time of forming lens portions on the both sides of the substrate, the respective optical axes of the both lens portions can be made coincide with each other at once with sufficient accuracy.

In a wafer lens producing method described in claim 20 is a producing method of producing a wafer lens by using the wafer lens molding die described in any one of claims 10 to 17, includes a process of producing multiple sheets of wafer lenses by supplying a hardenable resin material separately between the substrate and each of the lens cavity and the mark cavity; a process of performing positioning by using an alignment mark portion formed by the mark cavity when stacking the multiple sheets of wafer lenses; and a process of joining the stacked wafer lenses.

According to the present invention, the respective optical axes of the lens portions disposed in the stacked wafer lenses can be made coincide with each other at once with sufficient accuracy.

### Advantageous Effects of Invention

According to the present invention, it becomes possible to provide a wafer lens with sufficient accuracy in which multiple lens portions and alignment mark portions are formed on a substrate, a molding die to mold this wafer lens, and a method of producing a wafer lens.

### BRIEF DESCRIPTION OF DRAWINGS

FIG. 1 is a flowchart showing a process of producing a wafer lens according to this embodiment.

FIG. 2 is a perspective view showing an example (a) of a lens master shape portion of a master die and examples (b) to (d) of a mark master shape portion.

FIG. 3 is a partial crass sectional view of a first master die BM1.

FIG. 4 is a perspective view showing an example (a) of a lens cavity LC of an intermediate molding die, and examples (b) to (d) of a mark cavity MC.

In FIG. 5, (a) is an illustration showing a cross section of one example (corresponding to FIG. 4(b)) of a lens cavity LC and a mark cavity in the intermediate molding die M, and (b) is a drawing in which the lens cavity LC is looked in the direction of an arrow VB, and (c) is a drawing in which the mark cavity MC is looked in the direction of an arrow VC.

FIG. 6 is a drawing for explaining processes (a) to (e) in associated with a producing method of a wafer lens.

FIG. 7 is a perspective view showing an example (a) of a lens portion L formed on a substrate and examples (b) to (d) of an alignment mark portion AM.

FIG. 8 is a top view of a wafer lens WL.

FIG. 9 is a schematic diagram for explaining processes (a) and (b) of producing a stack type lens by combining wafer lenses WL and WLT.

FIG. 10 is a perspective view showing modification examples (a) to (e) of the alignment mark portion AM formed on a substrate.

### DESCRIPTION OF EMBODIMENTS

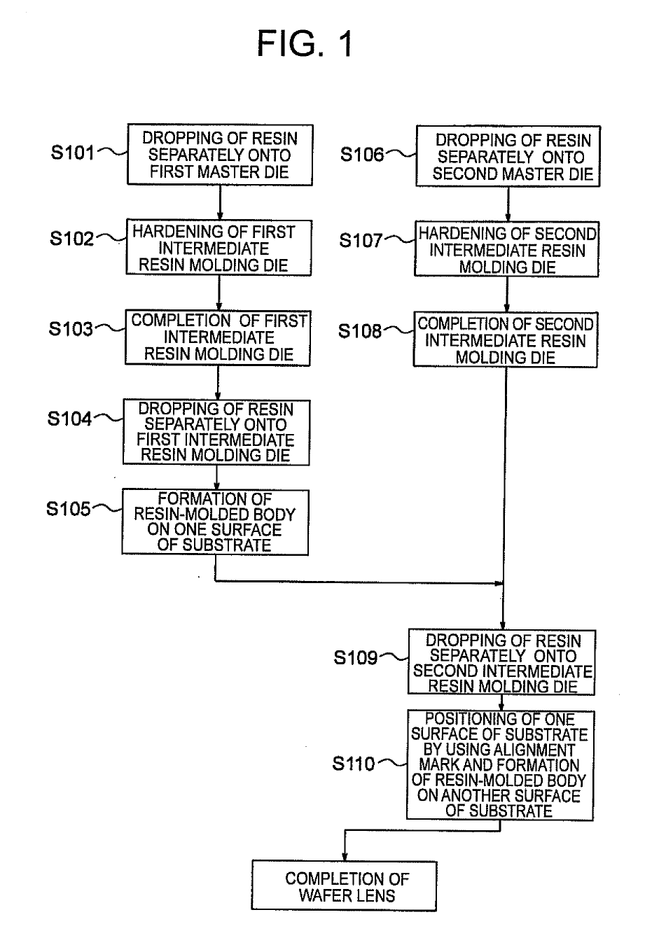

Hereafter, the embodiment of the present invention will be described based on the drawings. FIG. 1 is a flowchart showing a process of producing a wafer lens of this embodiment. Steps S101 to S303 show a process of producing a first intermediate molding die from a first master die, and steps S106 to S108 show a process of producing a second intermediate molding die from a second master die.

The first master die is used to form a first lens portion and a first alignment mark portion on a first surface of a substrate, and includes a lens master shape portion with a configuration corresponding to the first lens portion and a mark master shape portion with a configuration corresponding to the first alignment mark portion. The second master die is used to form a second lens portion and a second alignment mark portion on a second surface of the substrate, and includes a lens master shape portion with a configuration corresponding to the second lens portion, and a mark master shape portion with a configuration corresponding to the second alignment mark portion.

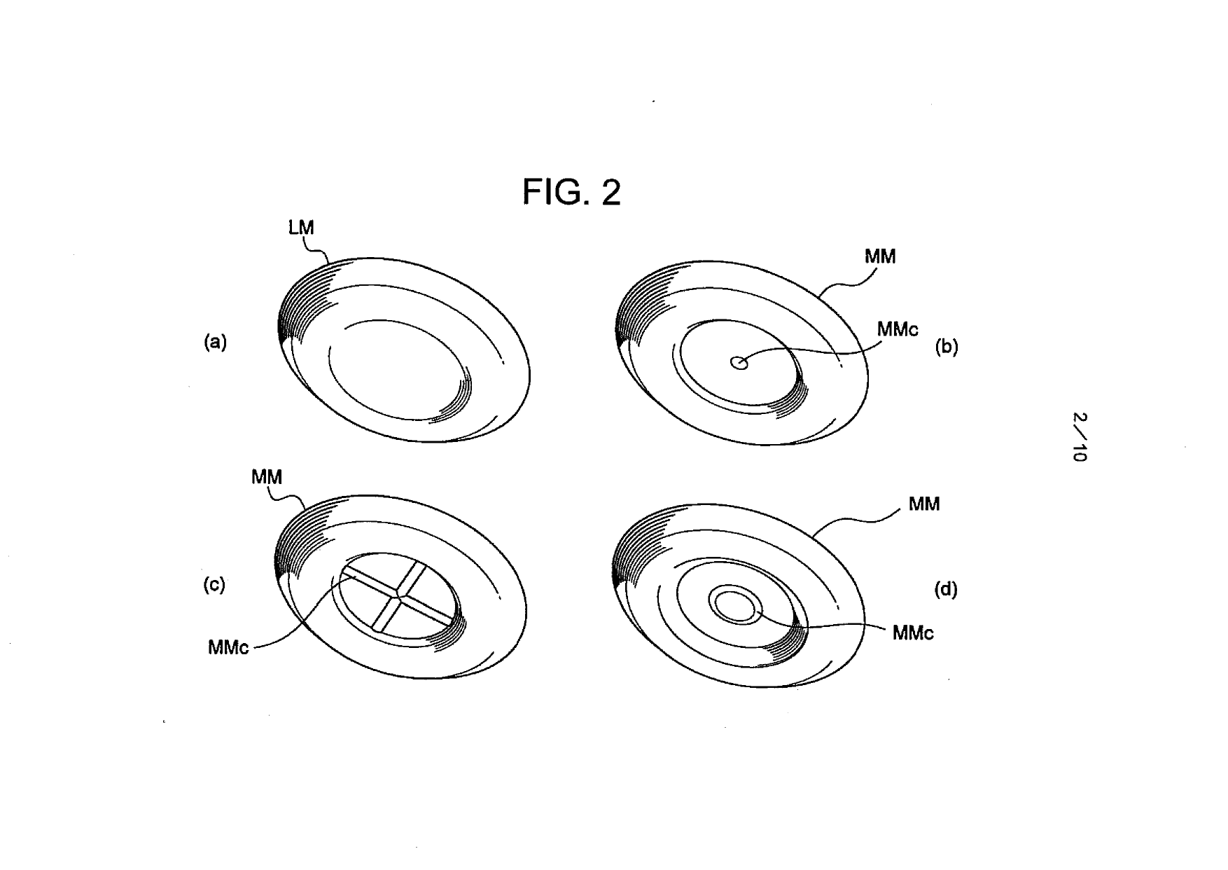

Here, an example of a lens master shape portion LM is shown in FIG. 2(a). Further, an example of a mark master shape portion MM is shown in FIGS. 2(b) to 2(d). Here, in the case where the mark master shape portion MM is formed on a die master material by a machining process, it is preferable to process a concave portion or a convex portion MMc to transfer a mark forming section of a later-mentioned mark cavity immediately after the machining process, because such a portion can be processed with good accuracy, and it becomes easy to make the position of the center of the mark cavity coincide with the center of the concave portion or the convex portion MMc.

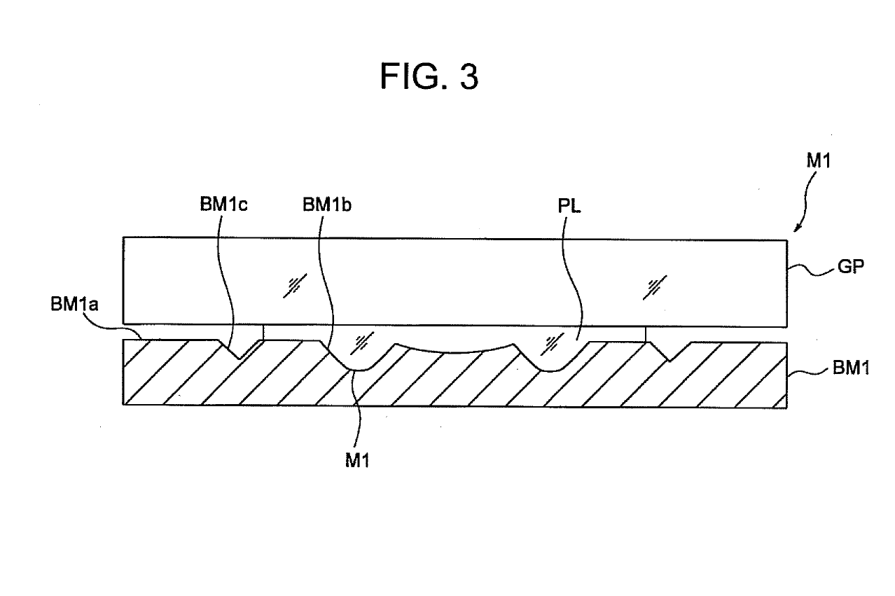

FIG. 3 is a partial sectional view of the first master die BM1, and a lens master shape portion BM1b (the similar configuration with LM shown in FIG. 2(a)) is formed on a flat surface BM1a. Although not illustrated in the drawing, a mark master shape portion (the similar configuration with MM shown in FIGS. 2(b) to 2(d)) is also disposed similarly. On the periphery of the lens master shape portion BM1b, an annular groove BM1c with a triangle-shaped cross sectional surface is formed. This is used to prevent a resin material from spreading at the time of producing the first intermediate molding die. Although the configuration of each of the lens master shape portion and the mark master shape portion is different, the second master die has the similar constitution.

At Step S101 in FIG. 1, a light hardenable resin material PL is dropped in the form of droplets separately to each of the lens master shape portion BM1b and a not-shown mark master shape portion of the first master die BM1, and a glass substrate GP is made to come close in parallel to the flat surface BM1a. Successively, at Step S102, light with a prescribed wavelength such as UV light is irradiated from the outside so as to harden the light hardenable resin material FL, and at Step S103, a first intermediate molding die M1 in which a resin-made molding transferring surface is stacked on the glass substrate GP is produced. Here, examples of the light hardenable resin material include a light hardenable resin material which contains an acrylic resin composition or an allyl resin composition as a main component and is hardened by radical polymerization, and a light hardenable resin material which contains an epoxy resin composition, an epoxy resin composition, or an oxetane compound as a main component and is hardened by cationic polymerization.

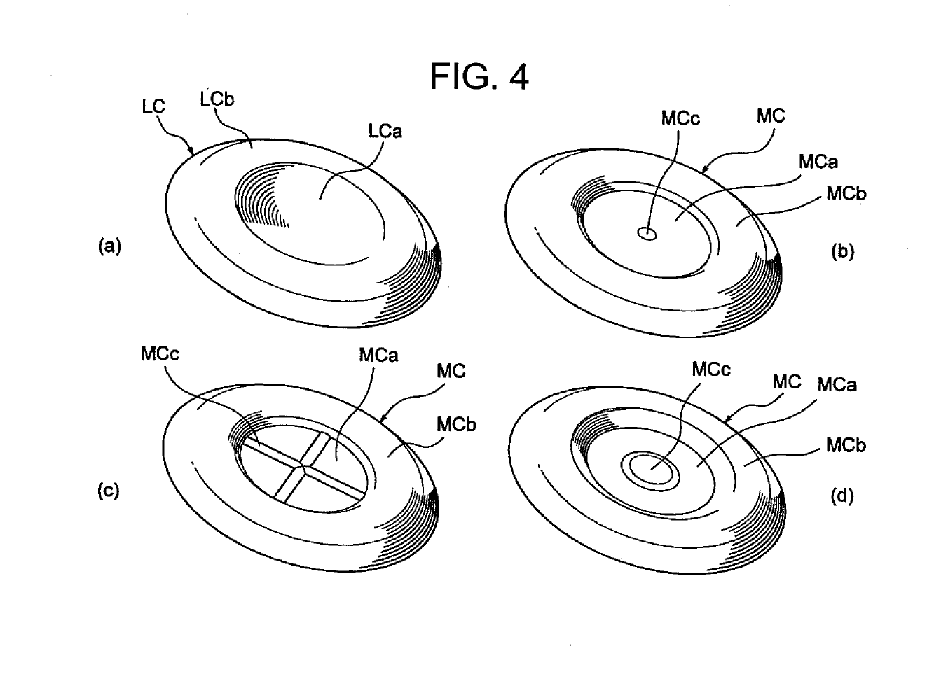

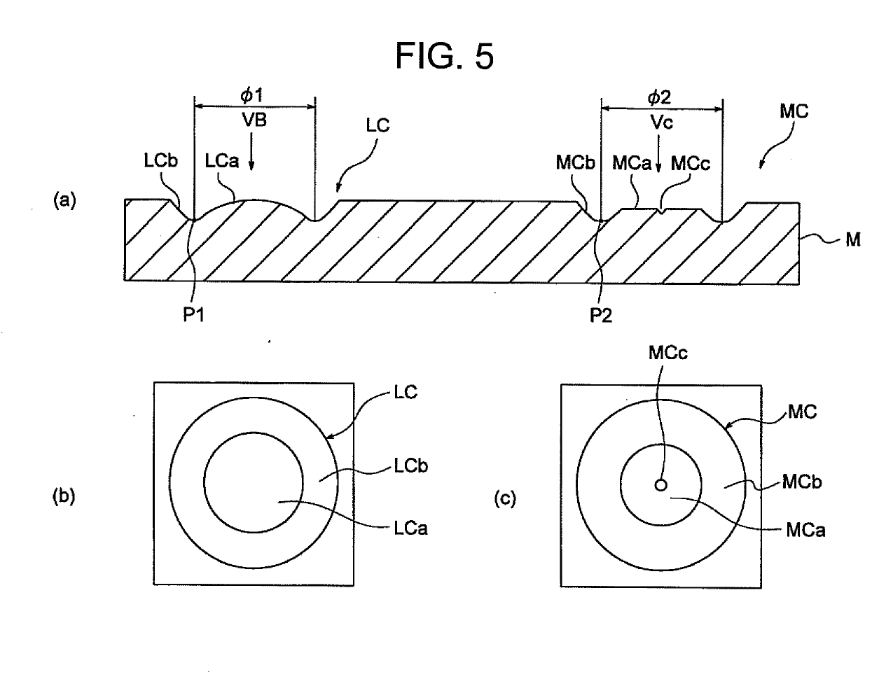

FIG. 4(a) shows one example of a lens cavity LC which is formed by being transferred from the lens master shape portion, and each of FIGS. 4(b) to 4(d) shows one example of a mark cavity MC which is formed by being transferred from the mark master shape portion. The Lens cavity LC includes an optical surface forming section LCa to form an optical surface of a lens portion, and a lens annular portion forming section LCb to form a lens annular portion around the optical surface. On the other hand, the mark cavity MC includes a flat surface portion forming section MCa to form a flat surface portion of an alignment mark portion, a mark annular portion forming section MCb to form a mark annular portion around the flat surface portion, and a mark forming section MCc to form an alignment mark AM on the flat surface portion. The outer diameter of the flat surface portion forming section MCa is preferably 0.14 to 2 mm. The mark forming section MCc has a configuration of a convex portion or a concave portion shaped in at least one of a circle, an arc, a straight line, and a combination of them. Although not illustrated in the drawing, a distance between neighboring lens cavities LC and a distance between a lens cavity LC and a mark cavity MC neighboring on the lens cavity LC are made equal to each other.

FIG. 5(a) is a drawing showing a cross sectional surface of one example (corresponding to FIG. 4 (b)) of a lens cavity LC and a mark cavity MC in the intermediate molding die M, FIG. 5(b) is a drawing which looks the lens cavity LC in the direction of an arrow VB, and FIG. 5(c) is a drawing which looks the mark cavity MC in the direction of an arrow VC. A diameter φ1 at the deepest position P1 on the lens annular portion forming section LCb is made equal to a diameter φ2 at the deepest position P2 of the mark annular portion forming section MCb. Further, a configuration at an outside from the point P1 of the lens annular portion forming section LCb is made substantially the same as that at an outside from the point P2 of the mark annular portion forming section MCb. This is also the same on the mark cavity shown in each of FIGS. 4(c) and 4(d). The volume of the lens cavity LC and the volume of the mark cavity MC are made substantially equal to each other.

In parallel to this, at Step S106 in FIG. 1, a light hardenable resin material is dropped in the form of droplets separately to each of the lens master shape portion and the mark master shape portion of the second master die, and a glass substrate GP is made to come close. Successively, at Step S107, light with a prescribed wavelength such as UV light is irradiated from the outside so as to harden the light hardenable resin material, and at Step S108, a second intermediate molding die M2 in which a resin-made molding transferring surface is stacked on the glass substrate is produced.

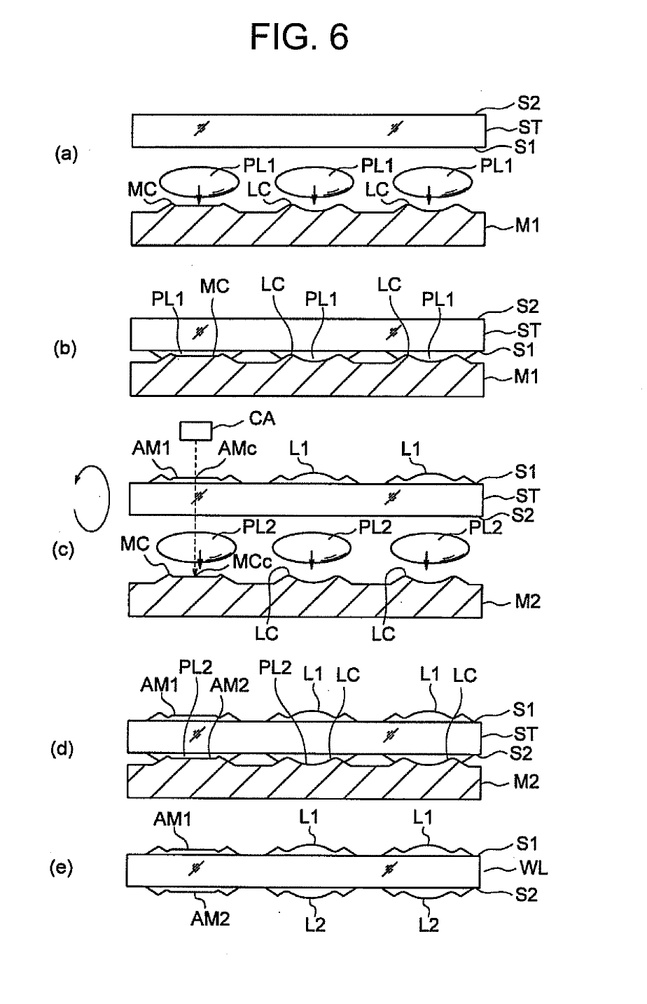

Next, description is given to an embodiment to produce a wafer lens by using the first intermediate molding die M1 and the second intermediate molding die M2. Although FIG. 6 is an illustration for explaining respective processes (a) to (e) according to a producing method of a wafer lens, the configuration of a lens portion and the configuration of an alignment mark portion are different from the respective actual configurations.

Here, a substrate ST made from a parallel plate glass (or resin) is prepared. However, as a previous process, a black resist material is coated on the substrate ST, and exposure via a mask and development are performed for it, whereby multiple apertures may be formed on the first surface S1 and second surface S2 of the substrate ST so as to match with lens portions to be molded. Each aperture exhibits a function of an aperture stop at the time of molding as an imaging lens.

Next, as shown in FIG. 6(a), a first resin material PL1 being a light hardenable resin material is dropped in the form of droplets separately to each of multiple lens cavities LC and mark cavities MC which are arranged in the form of a matrix on the first intermediate molding die M1 (Step S104 in FIG. 1), and the first intermediate molding die M1 is made to face the first surface counters S1 of the substrate ST and is subjected to positioning. Successively, as shown in FIG. 6(b), the first molding die M1 is made to come close relatively to the substrate ST, and the first resin material PL1 is sandwiched between the first molding die M1 and the substrate ST. As the first resin material, the similar light hardenable resin material with that used for the production of the intermediate molding die can be used.

On this condition, when light with a prescribed wavelength, such as UV light, is irradiated from the outside, the first resin material PL1 is hardened. Accordingly, with this, on the first surface S1 of the substrate ST, the first lens portions L1 transferred from the lens cavities LC of the first intermediate molding die M1 are formed, and the first alignment mark portions AM1 transferred from the mark cavities MC are formed (Step S105 of FIG. 1). At this time, the hardening may be advanced by heating the first resin material PL1 from the outside.

Subsequently, as shown in FIG. 6(c), the first intermediate molding die M1 is released, whereby the first lens portions L1 and the first alignment mark portions AM are formed in close contact with the first surface S1 of the substrate ST.

Successively, the substrate ST is reversed, and a second resin material PL2 being a light hardenable resin material is dropped in the form of droplets separately on the second surface S2 of the substrate ST (Step S109 in FIG. 1). Thereafter, a mark forming section MCc on a mark cavity MC of the second intermediate molding die M2 is observed by a camera CA through the flat surface portion of the transparent first alignment mark portion AM1. On this condition, even if the camera CA is not moved, the first alignment mark portion AM and the mark forming section MCc can be observed simultaneously by changing the focal distance of the optical system. As the second resin material, a light hardenable resin material similar to the first resin material can be used. The same material as the first resin material may be used.

Here, in the case where the first alignment mark portion AM is shifted from the mark forming section MCc of the mark cavity MC of the second intermediate molding die M2, if molding is performed on this condition, the optical axis of the second lens portion L2 transferred and molded from the lens cavity LC of the second intermediate molding die M2 does not coincide with the optical axis of the first lens portion L1 having been already molded. Then, the second molding die M2 is shifted relatively in the direction orthogonal to the optical axis relative to the substrate ST by a not-shown movable stage. With this, positioning is performed in such a way that the alignment mark AMc of the first alignment mark portion AM1 is made to coincide with the mark forming section MCc of the mark cavity MC of the second intermediate molding die M2. While maintaining this condition, the second intermediate molding die M2 is made to come close to the substrate ST, and as shown in FIG. 5(d), the second resin material PL2 is sandwiched between the substrate ST and the second intermediate molding die M2.

On such a condition, light with a prescribed wavelength such as UV light is irradiated from the outside, whereby the second resin material PL2 is hardened. With this, the second lens portions L2 are formed on the second surface S2 of the substrate ST (Step S110 in FIG. 1). At this time, the second resin material PL2 may be heated from the outside so as to advance the hardening of it. Subsequently, the second intermediate molding die M2 is released, whereby, as shown in FIG. 6 (e), the first lens portions L1 are formed in close contact with the first surface S1 of the substrate ST. As a result, a wafer lens WL in which the lens portions L1 and L2 are formed separately on the both sides (i.e., both surfaces) of the substrate ST can be obtained.

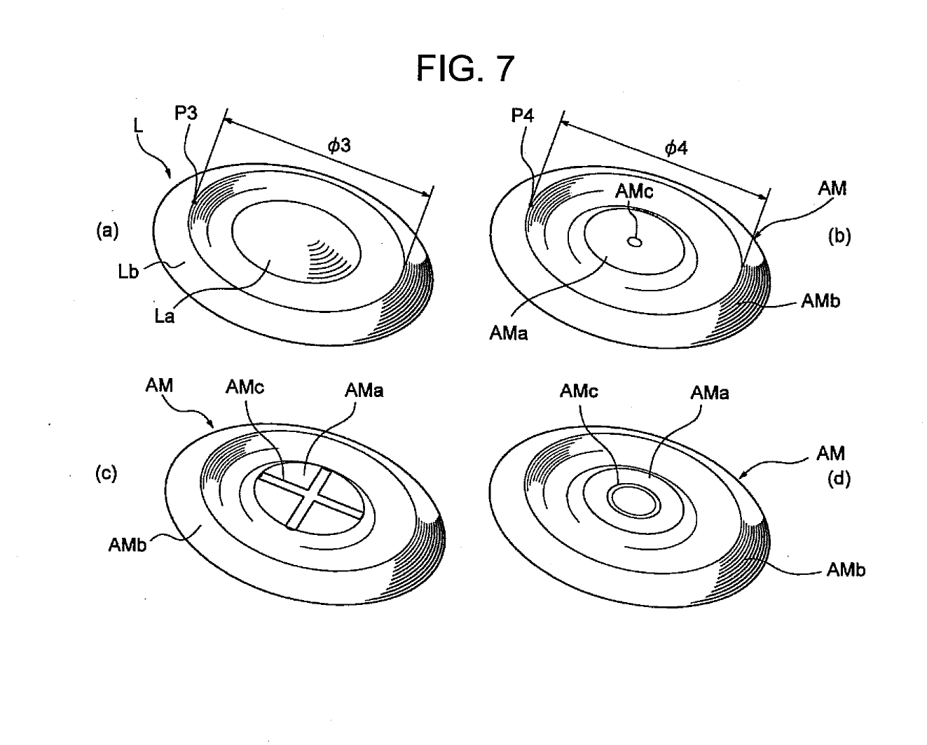

FIG. 7 (a) shows an example of the lens portion L formed by being transferred from the lens cavity LC, and each of FIG. 7 (b) to (d) shows an example of the alignment mark portion AM formed by being transferred from the mark cavity MC. The lens portion L includes an optical surface La at its central portion and a lens annular portion Lb symmetrical in terms of a point for the optical axis around the optical surface La. On the other hand, the alignment mark portion AM includes a flat surface portion AMa at its central portion, a mark annular portion AMb symmetrical in terms of a point for the optical axis around the flat surface portion AMa, and an alignment mark AMc formed on the flat surface portion AMa. The flat surface portion AMa is shaped in a circle with an outer diameter of 0.14 to 2 mm.

A diameter φ3 at the highest position (most distant, or furthest separated from the substrate ST) P3 of the lens annular portion Lb is made equal to a diameter φ4 at the highest position P2 of the mark annular portion AMb. Further, a volume at an inside of the lens annular portion Lb in the lens portion L (i.e., when the lens portion L is cut by an imaginary cylindrical surface which is coaxial with an optical axis and passes at the point P3, the volume of the lens portion L which becomes the inside of the imaginary cylindrical surface) is made substantially equal to a volume at an inside of the mark annular portion AMb of the alignment mark portion AM (i.e., when the alignment mark portion AM is cut by an imaginary cylindrical surface which is coaxial with an axis line and passes at the point P4, the volume of the alignment mark portion AM which becomes the inside of the imaginary cylindrical surface). With this, when a resin material is supplied between the substrate ST and each of the molding dies M1 and M2 by the separately-dropping method, it becomes possible to avoid the following problems. When the resin material is supplied too much, a large quantity of the resin material overflows from the mark cavity of the molding die to mold the alignment mark portion AM, and then, the overflowing resin material connects with the neighboring lens portions, which causes cracks at the time of cutting the wafer lens as mentioned later. On the other hand, when the resin material is supplied too small, the alignment mark portion AM cannot be formed with sufficient accuracy.

Furthermore, the configuration of the lens annular portion Lb at an outside from the point P3 is made substantially the same as that of the mark annular portion AMb at an outside from the point P4. This is the same in the alignment mark portion AM shown in each of FIGS. 7(c) to 7(d). With this, the situation of the spreading of the resin material at the time of separately-dropping on the lens portion becomes almost equal to that on the alignment mark portion. Accordingly, it becomes possible to reduce dispersion in dropping and molding, and it becomes easy to maintain quality at constant. Here, the alignment mark AMc shown in FIG. 7(b) is a small circle formed at the central portion of the flat surface portion AMa, the alignment mark AMc shown in

FIG. 7(c) is a cross-shaped groove formed at the central portion of the flat surface portion AMa, and the alignment mark AMc shown in FIG. 7(d) is a large circle formed at the central portion of the flat surface portion AMa.

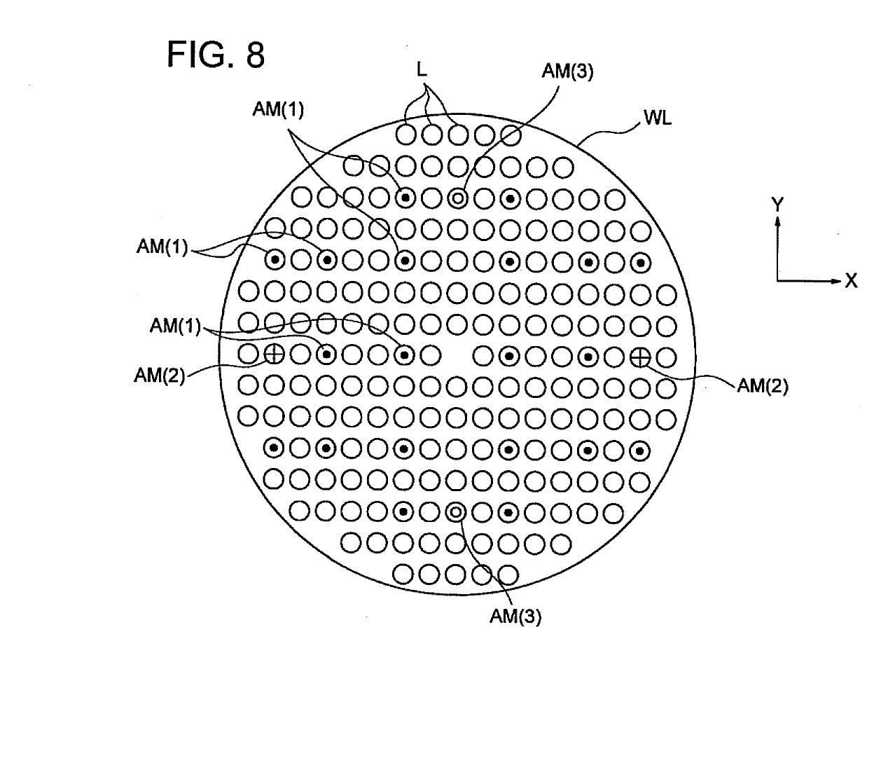

FIG. 8 shows an example of a wafer lens WL in which lens portions L, alignment mark portions AM (1), AM (2), and AM (3) are schematically formed in this way. In FIG. 8, a vertical direction is made into the Y direction, and a horizontal direction is made into the X direction. As can be clear from FIG. 8, the lens portion L as a resin-molded body and the alignment mark portions AM(1), AM(2), and AM(3) are arranged in the form of a matrix with an equal pitch between them to each other in a state of coexisting with each other. With this, a number of lens portions L can be arranged efficiently with increased density.

Here, the alignment mark portion AM(1) is the same as that shown in FIG. 7(b), and is suitable to be used to detect whether dispersion in the pitch of the lens portions L formed in the wafer lens WL is within a reference value. Accordingly, a comparatively large number of the alignment mark portions AM(1) are arranged among the lens portions L.

Further, the alignment mark portion AM(2) is the same as that shown in FIG. 7 (c), and is suitable to be used to align the respective optical axes of the lens portions L1 and L2 formed separately on the both sides of the substrate ST as mentioned in the above with reference to FIG. 6 (c). In this example, the alignment mark portions AM(2) are arranged separately along the X direction, and the alignment mark is shaped in straight lines orthogonal to each other. Accordingly, it becomes possible to perform positioning in the two directions (X, Y) orthogonal to each other with sufficient accuracy, Furthermore, the alignment mark portion AM(3) is the same as that shown in FIG. 7 (d). In this example, the alignment mark portions AM(3) are arranged separately along the Y direction, and are suitable to be used at the time of stacking wafer lenses in the form of one on the top of another, as mentioned later. The alignment mark portions AM(1) to AM(3) are preferably shaped in the respective different configurations from each other to prevent erroneous detection.

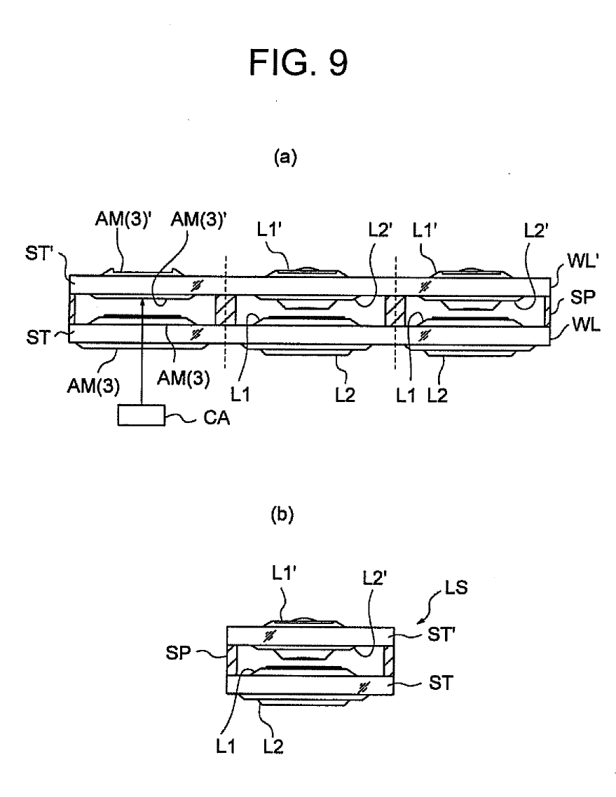

Furthermore, another wafer lens WL′ is formed through the same process such that a first lens portion L1′ and second lens portion L2′ are formed separately on a substrate ST′. Thereafter, as shown in FIG. 9 (a), with a camera CA, another (a rear side) alignment mark portion AM(3)′ formed on the substrate ST′ is observed through an (a front side) alignment mark portion AM(3) formed on the substrate ST. With this, while aligning the respective optical axes of the respective lenses of the two wafer lenses WL and WL′, the two wafer lenses WL and WL′ are superimposed on each other via a lattice-shaped spacer SP, coated with an adhesive, and fixed. In this case, it is preferable that the area of the flat surface portion of the front side alignment mark portion AM(3) is made larger than that of the flat surface portion of the rear side alignment mark portion AM(3)′, because it is easy to observe the rear side alignment mark portion AM(3)′ through the flat surface portion.

Thereafter, an intermediate production body in which the wafer lenses WL and WL′ are jointed to each other is cut out along each of positions indicated with a dotted line shown in FIG. 9(a) with a dicing cutter, in such a way that the lenses arranged in a flat surface direction are separated from each other, whereby lens units LS made separately in respective individual pieces shown in FIG. 9(b) can be obtained.

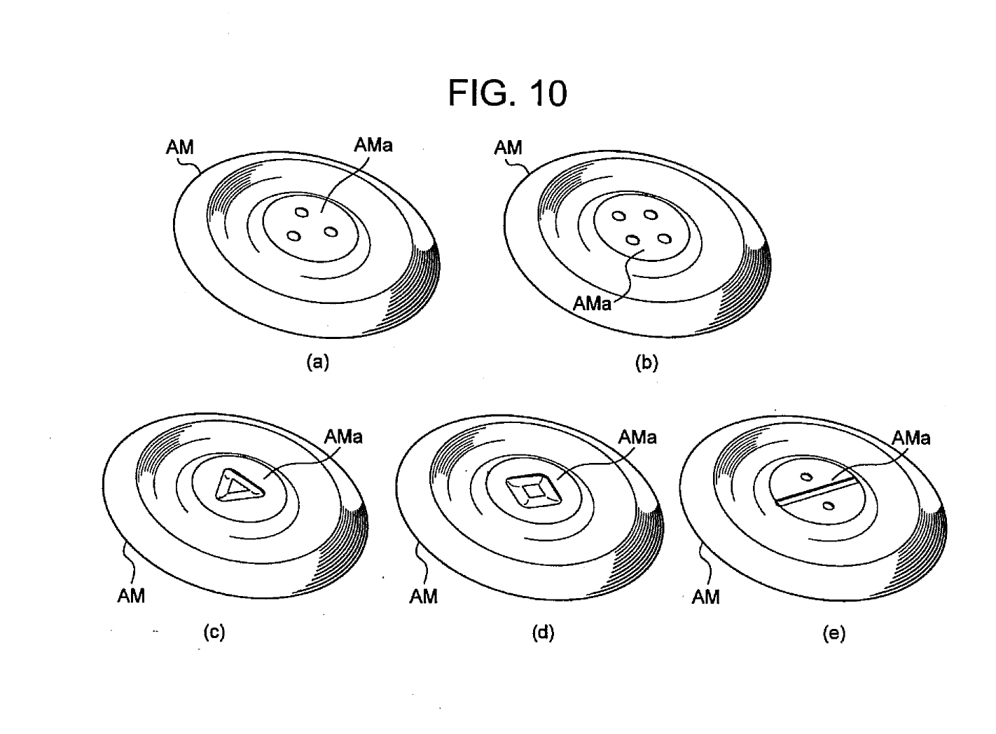

FIG. 10 is an illustration showing modification examples of an alignment mark portion AM. In the alignment mark portion AM shown in FIG. 10(a), a concave small circle is disposed on each of three apexes of a triangle (preferably, an equilateral triangle) on the flat surface portion AMa. In the alignment mark portion AM shown in FIG. 10(b), a concave small circle is disposed on each of four apexes of a quadrangle (preferably, a regular tetragon) on the flat surface portion AMa. In the alignment mark portion AM shown in FIG. 10(c), a thin groove is shaped in a configuration equivalent to a locus formed by moving a small circle along a side of a triangle (preferably, an equilateral triangle) on the flat surface portion AMa. In the alignment mark portion AM shown in FIG. 10(d), a thin groove is shaped in a configuration equivalent to a locus formed by moving a small circle along a side of a quadrangle (preferably, a regular tetragon) on the flat surface portion AMa. It may be preferable that the outer wall of the thin groove is composed of an arc and a straight line and an inner wall is composed of only a straight line. In the alignment mark portion AM shown in FIG. 10(e), straight line-shaped groove is formed between two concave small circles on the flat surface portion AMa.

The present invention should not be limited to the embodiment described in the specification, and it is apparent for a person skilled in the art from the embodiment and technical concept described in the specification that the present invention includes the other modification embodiment. The description and the embodiment in the specification are made merely for the purpose of exemplification, and the scope of the present invention is indicated with later-mentioned claims.

For example, stacked layers of a wafer lens are not only two layers, but may be three layers or more. Further, in this embodiment, lenses arranged in the flat surface direction are cut into an individual piece for each lens portion so as to obtain an imaging lens. However, the lenses may be cut for every multiple lenses so as to obtain an imaging lens which includes multiple lenses when being viewed from the optical axis direction. Such an imaging lens can be used as a compound eye lens used for a so-called compound eye type imaging device which obtains an image with higher resolution by synthesizing multiple images obtained at the time that the multiple stacked-lenses arranged in the flat surface direction form the respective images on the respective different positions.

Furthermore, in this embodiment, the intermediate molding die is formed by resin from a machined master die, and a wafer lens is produced by using it. However, a wafer lens may be formed directly from a machined molding die. In this case, although the producing cost increases, it becomes possible to produce a wafer lens with a more exact expected lens configuration. Further, in this case, it is preferable that a concave portion or convex portion adapted to form an alignment mark is processed immediately after processing a mark cavity. Furthermore, in the above embodiment, as a material used for a lens portion, an alignment mark portion, and an intermediate molding die, the light hardenable resin material has been used. However, other energy hardenable resin materials, such as heat hardenable resin materials may be used.

### REFERENCE SIGNS LIST

AM, AM1, AM(1), AM(2), and AM(3) Alignment mark portion
AMa Flat surface portion
AMb Mark annular portion
AMc Alignment mark
BM1 Master die
BM1a Flat surface
BM1b Lens master shape portion
BM1c Groove
CA Camera
GP Glass substrate
L Lens portion
L1 First lens portion
L2 Second lens portion
LC Lens cavity
LCa Optical surface forming section
LCb Lens annular portion forming section
LS Lens unit
La Optical surface
Lb Lens annular portion
M Intermediate molding die
M1 First intermediate molding die
M2 Second intermediate molding die
MC Mark cavity
MCa Flat surface portion forming section
MCb Mark annular portion forming section
MCc Mark forming section
PL1 First resin material
PL2 Second resin material
S1 First surface
S2 Second surface
SP Spacer
ST Substrate
WL Wafer lens

1. A wafer lens, comprising:
a substrate; and
a resin-molded body which comprises a plurality of portions provided with a distance on at least one surface of the substrate and is composed of a hardenable resin material;
wherein the resin-molded body includes a lens portion and at least two alignment mark portions, the lens portion includes an optical surface and a lens annular portion formed at a periphery of the optical surface, and the alignment mark portion includes a flat surface portion on which an alignment mark is formed and a mark annular portion formed at a periphery of the flat surface portion, and wherein a volume at an inside of the lens annular portion of the lens portion is made substantially equal to a volume at an inside of the mark annular portion of the alignment mark portion.

2. The wafer lens described in claim 1, wherein the flat surface portion on which the alignment mark is formed has an outer diameter of 0.14 to 2 mm.

3. The wafer lens described in claim 1, wherein the alignment mark is constituted by at least one of a circle, an arc, and a straight line.

4. The wafer lens described in claim 1, wherein the diameter of the lens annular portion at a position most distant from the substrate is made equal to the diameter of the mark annular portion at a position most distant from the substrate.

5. The wafer lens described in claim 1, wherein on a cross sectional surface of the resin-molded body in the optical axis direction passing through the optical axis of the lens portion, the outer shape of the lens annular portion is made substantially the same as the outer shape of the mark annular portion.

6. The wafer lens described in claim 1, wherein in the resin-molded body, the lens portion and the alignment mark portion are arranged with an equal pitch.

7. The wafer lens described in claim 1, wherein the lens portion is formed on both sides of the substrate, and one of the alignment mark portions is used for positioning at the time of forming the lens on the both sides of the substrate.

8. The wafer lens described in claim 1, wherein one of the alignment mark portions is used to detect a pitch error of the resin-molded body.

9. The wafer lens described in claim 1, wherein when stacking multiple wafer lenses in a form of one on top of another, one of the alignment mark portions is used for positioning of the wafer lenses to be stacked.

10. A wafer lens molding die which is arranged to face at least one surface of a substrate and configured to form a resin-molded body including a lens portion and at least two alignment mark portions by sandwiching a hardenable resin material with the substrate therebetween, the wafer lens molding die comprising:
a lens cavity for forming the lens portion; and
a mark cavity for forming the alignment mark portion,
wherein the lens cavity includes an optical surface forming section for forming an optical surface of the lens portion and a lens annular portion forming section for forming a lens annular portion around the optical surface,
wherein the mark cavity includes a flat surface portion forming section for forming a flat surface portion of the alignment mark portion and a mark annular portion forming section for forming a mark annular portion around the flat surface portion, and
wherein a volume of the lens cavity and a volume of the mark cavity are made substantially equal to each other.

11. The wafer lens molding die described in claim 10, wherein the flat surface portion forming section has an outer diameter of 0.14 to 2 mm.

12. The wafer lens molding die described in claim 10, wherein on the flat surface portion forming section, a concave potion or a convex portion each constituted by at least one of a circle, an arc, and a straight line, is disposed, and the alignment mark is formed by transferring the concave potion or the convex portion.

13. The wafer lens molding die described in claim 12, wherein the concave portion or the convex portion is processed immediately after the mark cavity has been processed.

14. The wafer lens molding die described in claim 10, wherein a diameter of the lens annular portion forming section at a deepest position is made equal to a diameter of the mark annular portion forming section at a deepest position.

15. The wafer lens molding die described in claim 10, wherein when taking a cross sectional surface, an outer shape of the lens annular portion forming section is made substantially the same as an outer shape of the mark annular portion forming section.

16. The wafer lens molding die described in claim 10, wherein a distance between neighboring lens cavities is made equal to a distance between neighboring lens cavity and a mark cavity.

17. The wafer lens molding die described in claim 10, wherein the molding die includes a resin-made molding transferring surface obtained by being transferred from the master die.

18. A producing method of producing a wafer lens by using the wafer lens molding die described in claim 10, comprising:
a process of supplying a hardenable resin material separately between the substrate and each of the lens cavity and the mark cavity, and
a process of detecting a pitch error of a resin-molded body formed on the substrate by using an alignment mark portion formed by the mark cavity.

19. A producing method of producing a wafer lens by using a pair of the wafer lens molding dies described in claim 10, comprising:
a process of supplying a first hardenable resin material separately between one surface of the substrate and each of the lens cavity and the mark cavity of one of the molding dies;
a process of positioning anther one of the molding dies on one surface of the substrate by using an alignment mark portion formed by the mark cavity; and
a process of supplying a second hardenable resin material separately between another surface of the substrate and each of the lens cavity and the mark cavity of another one of the molding dies.

20. A producing method of producing a wafer lens by using the wafer lens molding die described in claim 10, comprising:
a process of producing multiple sheets of wafer lenses by supplying a hardenable resin material separately between the substrate and each of the lens cavity and the mark cavity;
a process of performing positioning by using an alignment mark portion formed by the mark cavity when stacking the multiple sheets of wafer lenses; and
a process of joining the stacked wafer lenses.
